(19) United States
(12) Patent Application Publication
(10) Pub. No.: US 2016/0044767 A1
(43) Pub. Date: Feb. 11, 2016

(54) TRANSPARENT ELECTRODE FOR DISPLAY DEVICE HAVING HIGH TRANSMISSIVITY

(71) Applicant: U.I. Display Co., Ltd., Sejong-si (KR)

(72) Inventors: Young Ho DO, Chungcheongbuk-do (KR); Hee Soo SONG, Gyeonggi-do (KR); Maeng Hyun KIM, Gyeongsangbuk-do (KR)

(21) Appl. No.: 14/696,181

(22) Filed: Apr. 24, 2015

(30) Foreign Application Priority Data
Aug. 7, 2014 (KR) 10-2014-0101778

(51) Int. Cl. H05F 1/00; G02F 1/1333

(52) U.S. Cl. CPC H05F 1/00; G02F 1/1333

(57) ABSTRACT

Disclosed is a transparent electrode implementing high transmissivity while preventing static electricity. The transparent electrode includes a transparent film arranged on a transparent substrate, a static electricity prevention film arranged on the transparent film, and an electrode layer arranged on the static electricity prevention film. Here, the transparent film has a thickness of 180 Å to 220 Å, the static electricity prevention film has a thickness of 550 Å to 750 Å, and the electrode layer has a thickness of 180 Å to 220 Å.

This work was supported by the Industrial Technology Innovation Program funded by the Ministry of Trade, Industry and Energy (MOTIE, Korea)” (No. 10040000).

### CROSS-REFERENCE TO RELATED APPLICATION

This application claims priority to and the benefit of Korean Patent Application No. 10-2014-0101778, filed on Aug. 7, 2014, the disclosure of which is incorporated herein by reference in its entirety.

### BACKGROUND

1. Field of the Invention

The present invention relates to a transparent electrode for a display device.

2. Discussion of Related Art

Display technology is technology of visually transmitting a variety of information such as characters, photographs, images, etc. Currently, studies for next generation display technology are actively proceeding in Samsung, LG Corp., Liquorvista B. V., Koninklijke Philips N. V., etc.

Since glass used in a liquid crystal display panel process is alkali-free glass, which is an insulator, it is easy to generate static electricity, and an electrostatic charge on a substrate is not easily mitigated while a glass substrate maintains an induced charge. As a result, since a next process for manufacturing a liquid crystal display panel is performed in a state in which the generated charge is maintained, the static electricity discharge is generated, and at this time, there is a possibility of defects occurring due to insulation breakdown of an element.

Accordingly, in order to control the static electricity suitably in the process of manufacturing the liquid crystal display panel with a horizontal alignment mode, since there is no wire pattern of a conductive film on an upper substrate, image defects due to specific static electricity are solved using a method of forming a transparent conductive layer having a sheet resistance which is equal to or less than 2×10¹⁴ Ω/sq in an upper polarizing plate itself or on the top or bottom of the upper substrate.

Conventional Art Patent: Korea Patent Publication No. 2006-0131014 (Publication date: Dec. 20, 2006).

### SUMMARY OF THE INVENTION

The present invention is directed to a transparent electrode for a liquid crystal display device capable of implementing high transmissivity while preventing static electricity.

According to one aspect of the present invention, there is provided a transparent electrode for a display device, including: a transparent film arranged on a transparent substrate; a static electricity prevention film arranged on the transparent film to prevent static electricity; and an electrode layer arranged on the static electricity prevention film, wherein the transparent film has a thickness of 70 Å to 130 Å, the static electricity prevention film has a thickness of 400 Å to 600 Å, and the electrode layer has a thickness of 120 Å to 180 Å.

According to another aspect of the present invention, there is provided a transparent electrode for a display device, including: a transparent film arranged on a transparent substrate; a static electricity prevention film arranged on the transparent film to prevent static electricity; and an electrode layer arranged on the static electricity prevention film, wherein a thickness of the insulating layer is 3.1 to 8.6 times of that of the transparent film, and is 2.2 to 5.0 times that of the electrode layer.

According to still another aspect of the present invention, there is provided a transparent electrode for a display device, including: a transparent film arranged on a transparent substrate; an insulating layer arranged on the transparent film; and an electrode layer arranged on the insulating layer, wherein the transparent film has a thickness of 70 Å to 130 Å, the insulating layer has a thickness of 400 Å to 600 Å, and the electrode layer has a thickness of 120 Å to 180 Å.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a structure of a liquid crystal device according to an embodiment of the present invention;

FIG. 2 is a diagram illustrating a transparent electrode according to an embodiment of the present invention; and

FIG. 3 is a diagram for describing a process of manufacturing a transparent electrode using a sputtering process according to an embodiment of the present invention.

### DETAILED DESCRIPTION OF EXEMPLARY EMBODIMENTS

Hereinafter, exemplary embodiments of the present invention will be described in detail below with reference to the accompanying drawings.

The present invention may relate to an electrode of a display device, more particularly, a liquid crystal display panel (hereinafter referred to as “LCD panel”), and the electrode may have excellent transmissivity characteristics. For example, the electrode may be a transparent electrode, and be implemented as a multi-layer structure to have high transmissivity.

In an LCD panel of a twisted nematic (TN) liquid crystal mode, a transparent electrode in which there is no pattern on an upper substrate and a lower substrate may be arranged, in the LCD panel of a line switching (PLS) liquid crystal mode or an in-plane switching (IPS) liquid crystal mode, a transparent electrode which is patterned on the lower substrate may be arranged but the transparent electrode which is not patterned on the upper substrate may be arranged, and in the LCD panel of a patterned vertical alignment (PVA) liquid crystal mode, a transparent electrode which is patterned on each of the upper substrate and the lower substrate may be arranged.

Of course, there may be an LCD panel of another mode besides the modes described above, a transparent electrode having the multi-layer structure of the present invention may be applied to a transparent electrode of the LCD panel of every mode.

Particularly, the transparent electrode of the present invention may have high transmissivity characteristics while preventing driving defects due to an external electric field in the LCD panel of the PLS liquid crystal mode and the IPS liquid crystal mode.

Hereinafter, exemplary embodiments of the present invention will be described in detail with reference to the accompanying drawings. Here, for convenience of explanation, it will be assumed that the display device is an LCD device.

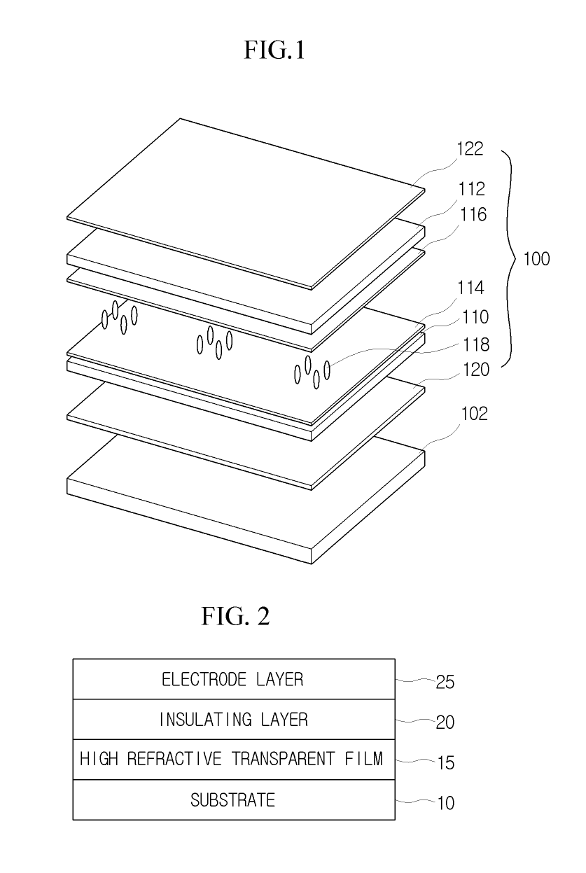

FIG. 1 is a diagram illustrating a structure of a liquid crystal device according to an embodiment of the present invention. In FIG. 1, for convenience of understanding and explanation, the LCD panel of the TN liquid crystal mode is illustrated.

Referring to FIG. 1, an LCD device according to an embodiment of the present invention may include an LCD panel 100 and a backlight 102 for providing light to the LCD panel 100.

The LCD panel 100 may include a first polarizing plate 120, a second polarizing plate 122, a first substrate 110, a second substrate 112, a first electrode 114, a second electrode 116, and a liquid crystal layer 118. Although not shown, an alignment layer used for uniformly aligning liquid crystals of the liquid crystal layer 118 may be located on each of the electrodes 114 and 116.

In the structure of FIG. 1, since elements other than the electrodes are already well known, description thereof will be omitted.

FIG. 2 is a diagram illustrating a transparent electrode according to an embodiment of the present invention.

Referring to FIG. 2, a transparent electrode of an embodiment of the present invention may include a high refractive transparent film 15, an insulating layer 20, and an electrode layer 25 which are sequentially arranged on a transparent substrate 10.

The transparent substrate 10 may be made of a material having excellent transmissivity with respect to visible rays, for example, a plastic film layer such as poly ethylene terephthalate (PET), a plastic sheet including acryl resins, etc., or half-tempered glass used for a display. The transparent substrate 10 may be desirable to have visible ray transmissivity which is equal to or more than 80%.

The high refractive transparent film 15 may be arranged on the transparent substrate 10, and be made of an oxide having high refractive characteristics and excellent transmissivity with respect to the visible light. For example, the high refractive transparent film 15 may be made of Nb₂O_{X}, more particularly, Nb₂O₅. The high refractive transparent film 15 may be made of a material having high refractive characteristics and high transmissivity, but is not be limited to Nb₂O_{X}, and may be made of a material such as TiO₂, SnO₂, etc.

According to an embodiment of the present invention, the high refractive transparent film 15 may have a thickness of 70 Å to 130 Å.

The insulating layer 20 may be formed on the high refractive transparent film 15, and may have relatively low reflectivity compared with the high refractive transparent film 15. For example, the insulating layer 20 may be made of SiO₂. The insulating layer 20 may perform a function of preventing static electricity. Accordingly, the insulating layer 20 may be referred to as a static electricity prevention film.

According to an embodiment of the present invention, the insulating layer 20 may have a thickness of 400 Å to 600 Å.

The electrode layer 25 may be an electrode to which power is applied, and be made of an indium tin oxide (ITO) having excellent electrical conductivity. Since the ITO may be a stable oxide of having high light transmission characteristics in a visible ray region, having excellent refractive characteristics in an infrared ray region, and having a low electric resistance at room temperature, the ITO may be used as the electrode layer 25.

According to an embodiment of the present invention, the electrode layer 25 may have a thickness of 120 Å to 180 Å.

As a result, the transparent electrode of the present invention may be implemented as a multi-layer structure, and the multi-layer structure may implement high transmissivity while preventing the static electricity.

More particularly, since the transparent substrate 10 generally uses alkali-free glass, it may be easy to generate the static electricity, and the electrostatic charge on the transparent substrate 10 may not be easily mitigated when the transparent substrate 10 maintains an induced charge, and the transparent substrate 10 may proceed to a next process as it is. As a result, when using the electrode layer which is made of the ITO, the static electricity may be easily generated in the LCD panel. In order to solve the static electricity problem, the transparent electrode of the present invention may have the multi-layer structure including the insulating layer 20 for preventing the static electricity.

Here, the insulating layer 20 may prevent the static electricity, but since the insulating layer 20 should not decrease transparency of the transparent electrode or generate another problem, a thickness of the insulating layer 20 may be set to 400 Å to 600 Å. Compared with the other films, the thickness of the insulating layer 20 may be about 3.1 times to 8.6 times that of the high refractive transparent film 15, and be about 2.2 times to 5.0 times that of the electrode layer 25. For example, a thickness of the insulating layer 20 may be about 5.0 times that of the high refractive transparent film 15, and be about 3.3 times that of the electrode layer 25. Detailed description thereof will be described later.

Meanwhile, in order to maintain high transmissivity while preventing the static electricity, the transparent electrode may include the high refractive transparent film 15 formed between the insulating layer 20 and the transparent substrate 10.

Further, the transparent electrode of the present invention may have higher transmissivity than a conventional transparent electrode and maintain the same resistance as the conventional transparent electrode.

Meanwhile, as described above, the transparent electrode may include one high refractive transparent film 15 and one insulating layer 20, but may include a plurality of repeatedly formed films formed by repeatedly forming the high refractive transparent film 15 and the insulating layer 20. For example, the transparent electrode may include a first refractive transparent film, a first insulating film, a second refractive transparent film, a second insulating film, and an electrode layer 25 which are sequentially formed on the transparent substrate 10.

Hereinafter, Embodiment and Comparative Examples according to the structure of FIG. 2 will be described. Meanwhile, in order to use actually as the transparent electrode for the display device, electrical characteristics such as transmissivity and a resistance, etc. of the transparent electrode should satisfy a specific condition. The specific condition may have characteristics of a sheet resistance of 400 Ω/sq to 500 Ω/sq, transmissivity which is equal to or more than 97%, and reflectivity which is equal to or less than 10%, and which score 0 to 3 on CIE(Commission Internationale de I'Eclairage Color Model) a* and 0 to −6 on CIE b*.

### (1) EMBODIMENT

The transparent electrode may be manufactured by a sputtering process, and an inner temperature of a chamber may be maintained at 30° C. to 30° C. In this condition, Nb₂O₅ having a thickness of 100 Å may be used as the high refractive transparent film 15, SiO₂ having a thickness of 500 Å may be used as the insulating layer 20 which is a static electricity prevention film, and an ITO having a thickness of 150 Å may be used as the electrode layer 25.

### (2) COMPARATIVE EXAMPLE 1

The transparent electrode may be manufactured by a sputtering process, and an inner temperature of a chamber may be maintained at 30° C. to 35° C. In this condition, Nb₂O₅ having a thickness of 100 Å may be used as the high refractive transparent film 15, SiO₂ having a thickness of 500 Å may be used as the insulating layer 20, and an ITO having a thickness which is smaller than 100 Å may be used as the electrode layer 25.

### (3) COMPARATIVE EXAMPLE 2

The transparent electrode may be manufactured by a sputtering process, and an inner temperature of a chamber may be maintained at 30° C. to 35° C. In this condition, Nb₂O₅ having a thickness of 100 Å may be used as the high refractive transparent film 15, SiO₂ of a thickness having 500 Å may be used as the insulating layer 20, and an ITO having a thickness of 200 Å which is greater than 180 Å may be used as the electrode layer 25.

### (4) COMPARATIVE EXAMPLE 3

The transparent electrode may be manufactured by a sputtering process, and an inner temperature of a chamber may be maintained at 30° C. to 35° C. In this condition, Nb₂O₅ having a thickness of 100 Å may be used as the high refractive transparent film 15, SiO₂ having a thickness of 350 Å which is smaller than 400 Å may be used as the insulating layer 20, and an ITO having a thickness of 150 Å may be used as the electrode layer 25.

### (5) COMPARATIVE EXAMPLE 4

The transparent electrode may be manufactured by a sputtering process, and an inner temperature of a chamber may be maintained at 30° C. to 35° C. In this condition, Nb₂O₅ having a thickness of 100 Å may be used as the high refractive transparent film 15, SiO₂ having a thickness of 650 Å which is greater than 600 Å may be used as the insulating layer 20, and an ITO having a thickness of 150 Å may be used as the electrode layer 25.

### (6) COMPARATIVE EXAMPLE 5

The transparent electrode may be manufactured by a sputtering process, and an inner temperature of a chamber may be maintained at 30° C. to 35° C. In this condition, Nb₂O₅ having a thickness of 30 Å which is smaller than 70 Å may be used as the high refractive transparent film 15, SiO₂ having a thickness of 500 Å may be used as the insulating layer 20, and an ITO having a thickness of 150 Å may be used as the electrode layer 25.

### (7) COMPARATIVE EXAMPLE 6

The transparent electrode may be manufactured by a sputtering process, and an inner temperature of a chamber may be maintained at 30° C. to 35° C. In this condition, Nb₂O₅ having a thickness of 190 Å which is greater than 130 Å may be used as the high refractive transparent film 15, SiO₂ having a thickness of 500 Å may be used as the insulating layer 20, and an ITO having a thickness of 150 Å may be used as the electrode layer 25.

Embodiments of the present invention showed the test results in the following Table 1.

TABLE 1

| | | | | | Before etching (ITO surface) | | | | | | | |
|---|---|---|---|---|---|---|---|---|---|---|---|---|
| | | | | | | Transmission | | | | Reflective color | | |
| | Film thickness | | | | | color intensity | | | | intensity | | |
| Items | Nb₂O₅ | SiO₂ | ITO | Resistance | Transmissivity | L* | a* | b* | Reflectivity | L* | a* | b* |
| Embodiment | 100 | 500 | 150 | 450 | 98.4 | 99.36 | 0.03 | 1.13 | 8.96 | 36.02 | 0.42 | −3.52 |
| Comparative | 100 | 500 | 100 | 620 | 98.26 | 96.59 | 3.52 | 5.13 | 11.26 | 38.55 | 1.52 | −1.04 |
| Example 1 | | | | | | | | | | | | |
| Comparative | 100 | 500 | 200 | 300 | 97.92 | 97.03 | −1.14 | −3.09 | 11.93 | 39.35 | 2.02 | −6.82 |
| Example 2 | | | | | | | | | | | | |
| Comparative | 100 | 350 | 150 | 441 | 94.89 | 96.03 | −1.43 | 8.57 | 15.09 | 42.82 | −2.17 | 5.06 |
| Example 3 | | | | | | | | | | | | |
| Comparative | 100 | 650 | 150 | 435 | 96.48 | 96.52 | 1.40 | −3.02 | 15.42 | 38.15 | 4.14 | −9.58 |
| Example 4 | | | | | | | | | | | | |
| Comparative | 30 | 500 | 150 | 430 | 96.36 | 96.14 | −3.71 | −2.72 | 13.72 | 41.05 | −2.01 | −8.07 |
| example 5 | | | | | | | | | | | | |
| Comparative | 190 | 500 | 150 | 429 | 96.01 | 96.07 | 4.29 | 8.37 | 14.21 | 41.53 | 3.14 | 2.87 |
| Example 6 | | | | | | | | | | | | |

As can be seen from the above table 1, it may be confirmed that the sheet resistance of the transparent electrode of Embodiment of the present invention is 450 Ω/sq which is within a desired range, and the transmissivity may have about 98% which is within a desired range. Further, it may be confirmed that the reflectivity is 8.96% satisfying a range which is equal to or less than 10%, and the CIE a* and b* of reflective color intensity is within a desired range. That is, it may be confirmed that the transparent electrode according to an embodiment of the present invention is used as the transparent electrode of the display device since the specific condition described above is satisfied.

In Comparative Example 1 in which a thickness of an electrode layer 25 consisting of an ITO is 100 Å which is smaller than 120 Å, it may be confirmed that a sheet resistance of a transparent electrode is 620 Ω/sq which is beyond the specific condition range. That is, the transparent electrode may be difficult to be used as a transparent electrode for a display device due to a high resistance.

In Comparative Example 2 in which a thickness of an electrode layer 25 consisting of an ITO is 200 Å which is greater than 180 Å, it may be confirmed that a sheet resistance of a transparent electrode is 300 Ω/sq which is beyond the specific condition range. That is, the transparent electrode may not be suitable to use as a transparent electrode for a display device due to a low resistance.

In Comparative Example 3 in which a thickness of the insulating layer 20 consisting of SiO₂ is 350 Å which is smaller than 400 Å, since the transmissivity of the transparent electrode is smaller than 97% and a CIE a* of a reflective color intensity is smaller than 0, green variation in which the light emitted from the display device is shifted toward a green color may occur, and since the transmissivity of the transparent electrode is smaller than 97% and a CIE b* of a reflective color intensity is greater than 0, yellow variation in which the light emitted from the display device is shifted toward a yellow color may occur. As a result, it may be confirmed that the transparent electrode may be beyond the specific condition range.

In Comparative Example 4 in which a thickness of the insulating layer 20 consisting of SiO₂ is 650 Å which is greater than 600 Å, since the transmissivity of the transparent electrode is smaller than 97% and a CIE a* of a reflective color intensity is greater than 3, yellow variation in which the light emitted from the display device is shifted toward a yellow color may occur, and since the transmissivity of the transparent electrode is smaller than 97% and a CIE b* of a reflective color intensity is smaller than −6, green variation in which the light emitted from the display device is shifted toward a green color may occur. As a result, it may be confirmed that the transparent electrode may be beyond the specific condition range.

In Comparative Example 5 in which a thickness of the high refractive transparent film 15 consisting of Nb₂O₅ is 30 Å which is smaller than 70 Å, since the transmissivity of the transparent electrode is smaller than 97% and a CIE a* of a reflective color intensity is smaller than 0, yellow variation in which the light emitted from the display device is shifted toward a green color may occur, and since the transmissivity of the transparent electrode is smaller than 97% and a CIE b* of a reflective color intensity is smaller than −6, green variation in which the light emitted from the display device is shifted toward a green color may occur. As a result, it may be confirmed that the transparent electrode may be beyond the specific condition range.

In Comparative Example 6 in which a thickness of the high refractive transparent film 15 consisting of Nb₂O₅ is 190 Å which is greater than 130 Å, since the transmissivity of the transparent electrode is smaller than 97% and a CIE a* of a reflective color intensity is greater than 3, red variation in which the light emitted from the display device is shifted toward a red color may occur, and since the transmissivity of the transparent electrode is smaller than 97% and a CIE b* of a reflective color intensity is greater than 0, yellow variation in which the light emitted from the display device is shifted toward a yellow color may occur. As a result, it may be confirmed that the transparent electrode may be beyond the specific condition range.

As a result, when the high refractive transparent film 15 has a thickness of 70 Å to 130 Å, the insulating layer 20 has a thickness of 400 Å to 600 Å, and the electrode layer 25 has a thickness of 120 Å to 180 Å, it may be confirmed that the following specific condition in which the transparent electrode is suitable for a display device is satisfied.

Specific condition: Resistance: 400 to 500 Ω/sq

Transmissivity: equal to or more than 97%

Reflectivity: equal to or less than 10%

CIE a*: 0 to 3

CIE b*: 0 to −6

Hereinafter, a method of manufacturing a transparent electrode according to an embodiment of the present invention will be described.

According to an embodiment of the present invention, at least one among the high refractive transparent film 15, the insulating layer 20, and the electrode layer 25 may be formed by a pulsed direct current (DC) sputtering process. In order to prevent breakage of the LCD panel according to the sputtering process, an inner temperature of a chamber may be maintained at 30° C. to 35° C.

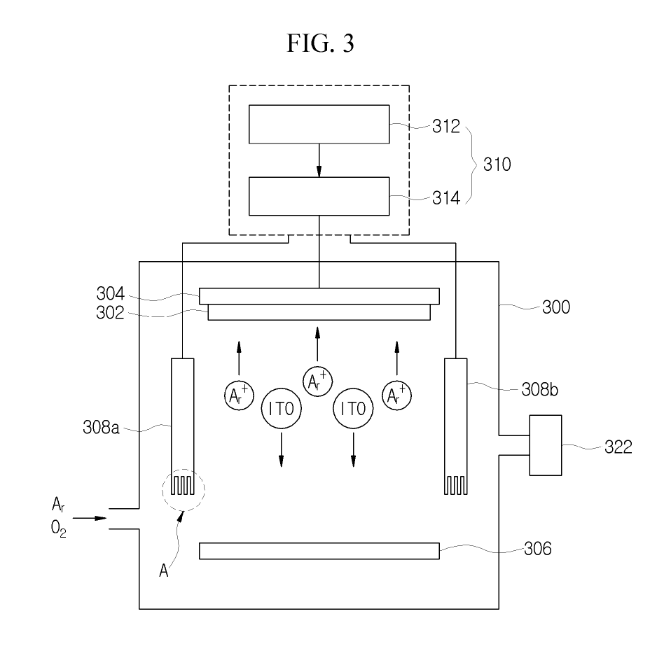

FIG. 3 is a diagram illustrating a method of manufacturing a transparent electrode using a sputtering process according to an embodiment of the present invention.

Referring to FIG. 3, a sputtering apparatus of an embodiment of the present invention may have an ITO target 302 fixed to a backing plate 304 in a chamber 300, and a substrate 306 located in the bottom of the chamber 300. Although not shown in FIG. 3, the substrate 306 may be arranged on a substrate holder.

As shown in FIG. 3, shields 308a and 308b may be arranged in a vertical direction of the ITO target 302, and be arranged outside the ITO target 302. Here, the shields 308a and 308b may have anode characteristics.

In a process of forming a high refractive transparent film using a direct current sputtering apparatus having the structure described above, the ITO target 302 may be installed, the transparent substrate 10 may be arranged, and the inside of the chamber 300 may be changed into a vacuum state.

Continuously, an inert gas (for example, argon gas (Ar)) and oxygen gas (O₂) mixed at a predetermined ratio may be inserted into the chamber 300. Here, the oxygen gas may be mixed at a ratio of 2.5% of the inert gas.

Continuously, a specific voltage may be applied to each of the ITO target 302 operating as a cathode and the shields 308a and 308b operating as an anode. For example, a specific direct current voltage may be applied to the ITO target 302, and voltages having square wave forms may be applied to the shields 308a and 308b. Here, one of the square wave forms may initially start from a positive voltage V1 and be changed while switching polarity, and the other of the square wave forms may initially start from a negative voltage −V1 and be changed while switching polarity. The square wave forms may be changed while switching to the polarities different from each other.

According to an embodiment, a pulse direct current power supply unit 310 may provide the voltages to the ITO target 302 and the shields 308a and 308b, and in order to provide the voltages having the square wave forms, may include a direct current power supply unit 312 and a distribution control unit 314.

The direct current power supply unit 312 may generate a constant direct current voltage, and the distribution control unit 314 may properly distribute the direct current as it is or a changed direct current after changing the direct current in a pulse form to the ITO target 302 and the shields 308a and 308b. Here, since the ITO target 302 has a high electric resistance, frequencies of the square wave forms may have 20 kHz to 150 kHz.

When the voltage is applied, a glow discharge may be performed on the argon gas Ar, and Ar+ ions may be generated, that is, the Ar gas may be changed into a plasma state. Here, as shown in FIG. 3, the Ar+ ions may collide with the ITO target 302 (although not shown, a collision may be activated using a magnetic force), and the ITO target 302 may be sputtered by the collision. The sputtered ITO may be deposited on the substrate 10 in which the high refractive transparent film 15 and the insulating layer 20 are formed. That is, the ITO film may be deposited as the electrode layer on the insulating layer 20.

Generally, when a resistance of the ITO target 320 is high and a simple sputtering method is used, since an arcing phenomenon may be generated, the arcing phenomenon may be prevented using the direct current sputtering method as described above. More particularly, since the square wave forms are changed while switching to the polarities different from each other, an electric field may be continuously changed, and thus the arcing may not be generated even though the resistance of the ITO target 302 is high. That is, the ITO film may be stably deposited on the substrate by applying the voltages having the square wave forms.

Although a duty ratio of the voltage applied to each of the shields 308a and 308b is 1, a duty ratio may be varied with a different ratio according to a purpose. Further, a circuit of supplying the voltage to the ITO target 302 may be separately present from the pulsed DC power supply unit 310.

The deposition of the high refractive transparent thin film layer of the present invention may use the DC sputtering method in order to improve a deposition speed, and more particularly, use the pulsed DC sputtering method in order to prevent the arcing due to the high resistance of the ITO target 302.

The transparent electrode according to the present invention may have high transmissivity while preventing the static electricity since the transparent electrode has the multi-layer structure including the high refractive transparent film, the static electricity prevention film, and the electrode layer. Further, the resistance may not be increased due to the multi-layer structure.

Accordingly, devices belonging to the field of transparent display devices, such as smart windows, flexible displays and transparent displays, which are highlighted in the display industry, are expected to be widely applied to automobiles, construction, mobile phones, health care, industrial applications, and even military equipment, and fields within the semiconductor industry are expected to generate high industrial/economic values.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A transparent electrode for a display device, comprising:
a transparent film arranged on a transparent substrate;
a static electricity prevention film arranged on the transparent film to prevent static electricity; and
an electrode layer arranged on the static electricity prevention film,
wherein the transparent film has a thickness of 70 Å to 130 Å, the static electricity prevention film has a thickness of 400 Å to 600 Å, and the electrode layer has a thickness of 120 Å to 180 Å.

2. The transparent electrode for the display device of claim 1, wherein the transparent electrode satisfies characteristics in which a sheet resistance of the transparent electrode is 400 Ω/sq to 500 Ω/sq, transmissivity is equal to or more than 97%, and reflectivity is equal to or less than 10%, and which scores 0 to 3 on CIE a* and 0 to −6 on CIE b*.

3. The transparent electrode for the display device of claim 1, wherein the display device is a liquid crystal display panel, and the electrode layer is deposited on the static electricity prevention film using a pulsed direct current sputtering process using an ITO target.

4. The transparent electrode for the display device of claim 1, wherein the transparent film is made of Nb₂O₅, the static electricity prevention film is made of SiO₂, and the transparent film has a higher refractive index than the static protective film.

5. A transparent electrode for a display device, comprising:
a transparent film arranged on a transparent substrate;
a static electricity prevention film arranged on the transparent film to prevent static electricity; and
an electrode layer arranged on the static electricity prevention film,
wherein a thickness of the insulating layer is 3.1 to 8.6 times that of the transparent film, and is 2.2 to 5.0 times of that of the electrode layer.

6. A transparent electrode for a display device, comprising:
a transparent film arranged on a transparent substrate;
an insulating layer arranged on the transparent film; and
an electrode layer arranged on the insulating layer,
wherein the transparent film has a thickness of 70 Å to 130 Å, the insulating layer has a thickness of 400 Å to 600 Å, and the electrode layer has a thickness of 120 Å to 180 Å.

7. The transparent electrode for the display device of claim 6, wherein the transparent electrode satisfies characteristics in which a sheet resistance of the transparent electrode is 400 Ω/sq to 500 Ω/sq, and transmissivity is equal to or more than 97%, and which scores 0 to 3 on CIE a* and 0 to −6 on CIE b*.
